(19) United States
(12) Patent Application Publication
(10) Pub. No.: US 2023/0288104 A1
(43) Pub. Date: Sep. 14, 2023

(54) APPARATUS FOR COOLING LCD PANEL OF 3D PRINTER

(71) Applicant: SINDOH CO., LTD., Seoul (KR)

(72) Inventors: Ji-sung PARK, Seoul (KR); Ju-hyung LEE, Seoul (KR)

(73) Assignee: SINDOH CO., LTD., Seoul (KR)

(21) Appl. No.: 17/689,383

(22) Filed: Mar. 8, 2022

(51) Int. Cl. F25B 21/02; B33Y 40/00

(52) U.S. Cl. CPC F25B 21/02; B33Y 40/00; F25B 2321/0251; B29C 64/124

(57) ABSTRACT

The present invention relates to an apparatus for cooling an LCD panel of a 3D printer that transmits the light irradiated from a light source module to the LCD panel and cures a photocurable resin in a water tank to produce a sculpture, the apparatus comprising: a sealed case arranged between the light source module and the LCD panel; and a cooling module installed on one side or lower surface of the sealed case and cooling the air inside the sealed case to cool the LCD panel.

### BACKGROUND OF THE INVENTION

### 1. Field of the Invention

The present invention relates to an LCD-type 3D printer, and more particularly, to an apparatus for cooling a LCD panel of a 3D printer capable of improving printing quality by cooling the LCD panel.

### 2. Description of the Prior Art

A 3D printer is a manufacturing device that produces an object by outputting successive layers of material like a two-dimensional printer and stacking them. These 3D printers are mainly used for prototype sample production because they can quickly produce objects based on digitized drawing information.

The product molding method of the 3D printer can be classified as follows: SLA (Stereo Lithography Apparatus) method in which a laser is injected into a photocurable resin to cure the injected portion; SLS (Selective Laser Sintering) method for sintering a functional polymer or metal powder; FDM (Fused Deposition Modeling) method of extruding and molding molten resin; DMT (Laser-aid Direct Metal Tooling) method for directly forming metal with a high-power laser beam; LOM (Laminated Object Manufacturing) method, which is a mechanical joint molding method; and DLP (Digital Light Processing) method to cure the resin by irradiating light to the lower part of the water tank where the photocurable resin is stored.

Among the product molding methods of the 3D printer, the DLP method has a short printing time because one surface is entirely cured at a time, but has a disadvantage in that the resolution varies depending on the printing area. In order to solve this problem, an LCD type 3D printer using an LCD panel has been proposed.

The LCD-type 3D printer has the advantage of being able to print a sculpture at the resolution of the LCD panel regardless of the printing area by installing the LCD panel between the light source and the tank in which the photocurable resin is stored.

However, when the temperature of the LCD panel increases due to the heat generated by the LCD panel itself and the heat generated inside the 3D printer, blackening occurs in the LCD panel, so that the light irradiated from the light source is not transmitted smoothly to the water tank. Accordingly, there is a problem that the molding quality is deteriorated.

### SUMMARY OF THE INVENTION

It is an object of the present invention to provide an apparatus for cooling a LCD panel of a 3D printer capable of effectively cooling the LCD panel to prevent the blackening of the LCD panel, thereby improving printing quality.

The present invention is an apparatus for cooling the LCD panel of the 3D printer that transmits the light irradiated from a light source module to the LCD panel and cures a photocurable resin in a water tank to produce a sculpture. The apparatus comprises a sealed case arranged between the light source module and the LCD panel; and a cooling module installed on one side or lower surface of the sealed case and cooling the air inside the sealed case to cool the LCD panel.

Preferably, the cooling module comprises: a cold side heat sink arranged inside the sealed case; a hot side heat sink arranged outside the sealed case; and a Peltier element installed between the cold side heat sink and the hot side heat sink, and when a current is applied, the contact surface of the Peltier element with the cold side heat sink is cooled and the contact surface of the Peltier element with the hot side heat sink is heated.

More preferably, the Peltier element is made of a pair and is arranged on the same line as one side of the sealed case, and is in surface contact with the cold side heat sink and the hot side heat sink.

Additionally, a cold air circulation fan is installed on the side opposite to one side of the cold side heat sink that is in contact with the Peltier element; and the cold air circulation fan is arranged to be spaced apart from the cold side heat sink by a predetermined distance through a bracket installed on the outside of the cold side heat sink, thereby forming an air flow path between the cold air circulation fan and the cold side heat sink.

In addition, a hot air exhaust fan is installed on the side opposite to one side of the hot side heat sink that is in contact with the Peltier element; and the hot air exhaust fan is arranged to be spaced apart from the hot side heat sink by a predetermined distance through a bracket installed on the outside of the hot side heat sink, thereby forming an air flow path between the hot air exhaust fan and the hot side heat sink.

Preferably, the cold side heat sink and the hot side heat sink are provided with a plurality of cooling fins extending in the horizontal direction and spaced apart from each other by a predetermined distance in the vertical direction, so that an air flow in the horizontal direction is generated in the cooling module.

More preferably, the hot side heat sink is accommodated in a duct communicating with the outside of the 3D printer, so that heat radiated from the hot side heat sink is discharged to the outside of the 3D printer without flowing into the 3D printer.

In addition, a heat insulating material is inserted into the inner surface of the sealed case.

Preferably, the light source module forms a bottom surface of the sealed case, and the LCD panel forms an upper surface of the sealed case.

Additionally, the apparatus further comprises a temperature sensor for measuring the temperature of the LCD panel, and when the temperature of the LCD panel is higher than or equal to a predetermined value as a result of the measurement of the temperature sensor, a current is applied to the Peltier element.

According to the present invention, the cold side heat sink in contact with the heat radiating surface of the Peltier element is cooled, and the hot side heat sink in contact with the heat absorbing surface of the Peltier element is heated, thereby cooling the air inside the sealed case. As a result, the LCD panel forming the upper surface of the sealed case is cooled, thereby preventing the blackening of the LCD panel. Therefore, it is possible to reliably prevent the deterioration of the quality of the output formed in the water tank.

According to the present invention, the cold air generated from the cooling module smoothly circulates inside the sealed case by the air flow path between the cold air circulation fan and the cold side heat sink and the cold air circulation fan. Thus, the LCD panel forming the upper surface of the sealed case can be cooled more efficiently.

According to the present invention, the hot air generated from the cooling module is smoothly discharged to the outside of the sealed case by the air flow path between the hot air exhaust fan and the hot side heat sink and the hot air exhaust fan, so that the cooling module can more smoothly generate cold air. Thus, the LCD panel forming the upper surface of the sealed case can be cooled more efficiently.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram schematically showing the configuration of an apparatus for cooling an LCD panel of a 3D printer according to the present invention;

FIG. 2 is a perspective view illustrating the apparatus for cooling the LCD panel of the 3D printer according to the present invention;

FIG. 3 is a perspective view illustrating the inside of the 3D printer in which the apparatus for cooling the LCD panel of the 3D printer according to the present invention is installed;

FIG. 4 is a perspective view illustrating a cooling module of the apparatus for cooling the LCD panel of the 3D printer according to the present invention;

FIG. 5 is a perspective view illustrating in another direction the cooling module of the apparatus for cooling the LCD panel of the 3D printer according to the present invention;

FIG. 6 is a plan view illustrating the cooling module of the apparatus for cooling the LCD panel of the 3D printer according to the present invention;

FIG. 7 is a plan sectional view illustrating the cooling module of the apparatus for cooling the LCD panel of the 3D printer according to the present invention;

FIG. 8 is a perspective view illustrating another example of the cooling module of the apparatus for cooling the LCD panel of the 3D printer according to the present invention; and

FIG. 9 is a side view illustrating the cooling module of FIG. 8.

### DETAILED DESCRIPTION OF THE EXEMPLARY EMBODIMENTS

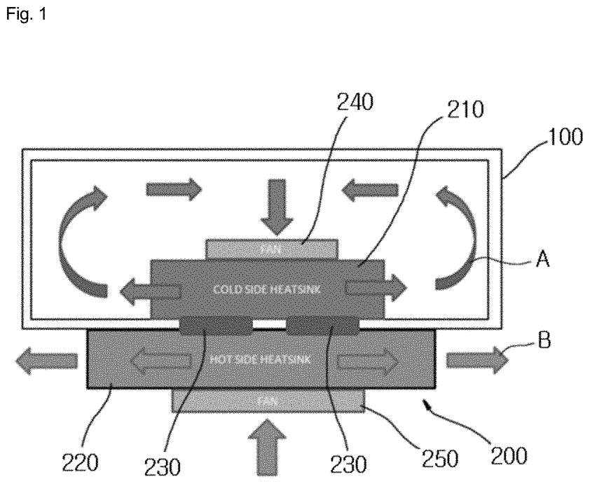

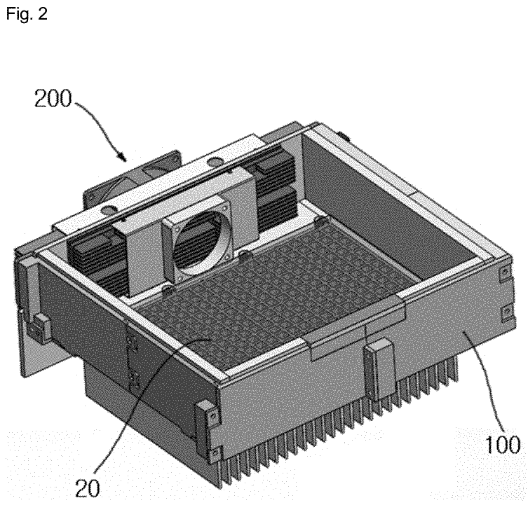

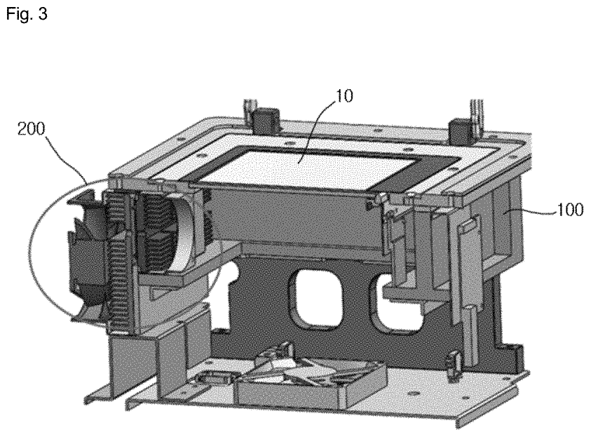

Referring to FIGS. 1 to 3, an apparatus for cooling an LCD panel of a 3D printer according to the present invention includes a sealed case 100 and a cooling module 200 for cooling the LCD panel 10 by cooling air inside the sealed case 100.

The 3D printer comprises a light source module 20 (for example, a LED light source module) arranged at the lower portion and irradiating light upward, the LCD panel spaced apart from the LED light source module 20 by a predetermined distance and arranged on the upper portion of the LED light source module 20, and a water tank (not shown) in which a photocurable resin is stored, wherein the photocurable resin is cured by the light of the LED light source module 20 passing through the LCD panel 10. The 3D printer transmits the light irradiated from the LED light source module 20 to the LCD panel to cure the photocurable resin in the water tank, thereby producing a sculpture.

The sealed case 100 is arranged between the LED light source module 20 and the LCD panel 10. The lower surface of the sealed case 100 is formed by the LED light source module 20, and the upper surface of the sealed case 100 is formed by the LCD panel 10.

The cooling module 200 is installed on one side of the side surfaces of the sealed case 100. The cooling module 200 cools the air inside the sealed case 100 to cool the LCD panel 10 forming the upper surface of the sealed case 100. Alternatively, the cooling module 200 may be arranged on the lower surface side of the sealed case 100.

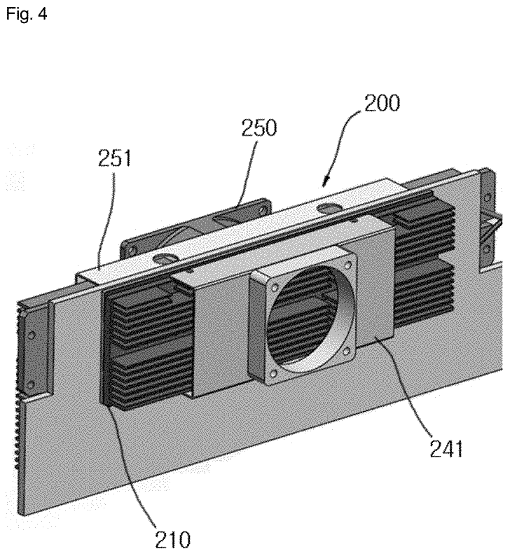

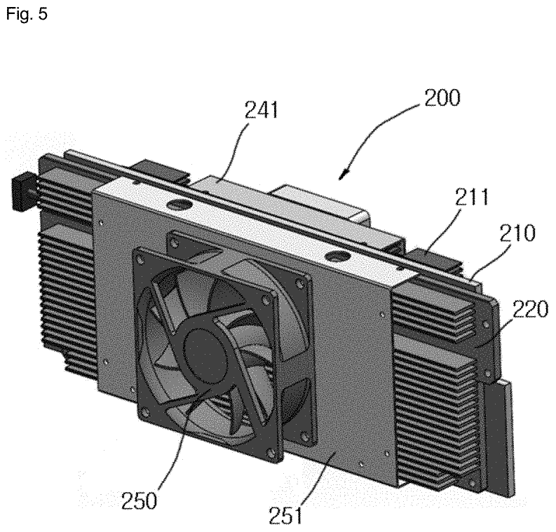

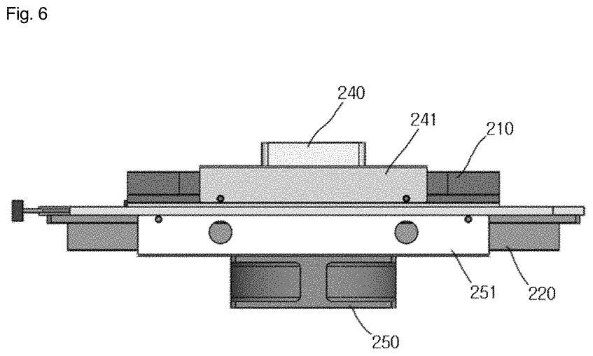

Referring to FIGS. 4 to 7, the cooling module 200 includes a cold side heat sink 210 arranged inside the sealed case 100, a hot side heat sink 220 arranged outside of the sealed case 100, and a Peltier element 230.

The cold side heat sink 210 and the hot side heat sink 220 are arranged adjacent to one side of the sealed case 100 to face each other in an adjacent state.

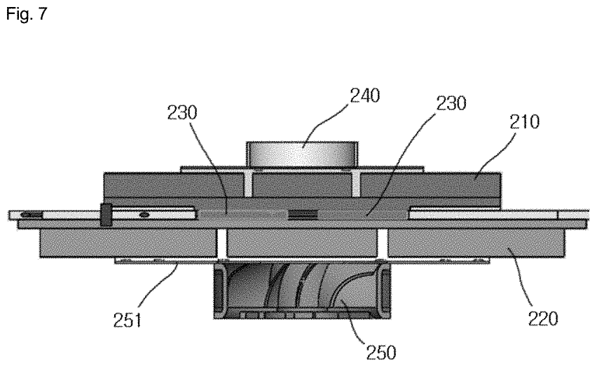

The Peltier element 230 performs heat radiating and heat absorbing functions by using Peltier effect. As a current is applied to the Peltier element 230, one side of the Peltier element 230 acts as a heat radiating surface to be cooled, and the other side acts as a heat absorbing surface to be heated. The Peltier element 230 has a plate-shaped structure. In the FIG. 7, the upper side of the Peltier element 230 generates cold air as a heat radiating surface, and the lower side of the Peltier element 230 generates hot air as a heat absorbing surface. The Peltier element 230 is installed between the cold side heat sink 210 and the hot side heat sink 220. Therefore, when a current is applied, the contact surface of the cold side heat sink 210 and the Peltier element 230 is cooled, and the contact surface of the hot side heat sink 220 and the Peltier element 230 is heated.

The Peltier element 230 is made of a pair and is arranged on the same line as one side of the sealed case 100 in a state spaced apart from each other. That is, the Peltier element 230 may be formed as a part of one side of the sealed case 100. In addition, the Peltier element 230 is arranged between the cold side heat sink 210 and the hot side heat sink 220 to make surface contact with the heat sinks 210 and 220.

Therefore, the cold side heat sink 210 in surface contact with the heat radiating surface of the Peltier element 230 is cooled and the hot side heat sink 220 in surface contact with the heat absorbing surface of the Peltier element 230 is heated. Thus, the air inside the sealed case 100 is cooled. Then, the LCD panel 10 forming the upper surface of the sealed case 100 is cooled, so that blackening of the LCD panel 10 can be prevented. As a result, it is possible to reliably prevent deterioration of the quality of the output formed in the water tank.

Preferably, a cold air circulation fan 240 is installed on the inner surface of the cold side heat sink 210, that is, on the surface opposite to the surface in surface contact with the Peltier element 230. The cold air circulation fan 240 is arranged to be spaced apart from the cold side heat sink 210 by a predetermined distance through a bracket 241 installed on the outside of the cold side heat sink 210.

Specifically, the bracket 241 is formed to surround the upper surface, the bottom surface and the rear surface of the cold side heat sink 210 protruding from one side of the sealed case 100 and is coupled to the cold side heat sink 210. In addition, an installation space for installing the cold air circulation fan 240 is provided on the rear side of the bracket 241. The rear surface of the bracket 241 is formed to be spaced apart from the rear surface of the cold side heat sink 210 by a predetermined distance, and an air flow path is formed between the cold air circulation fan 240 and the cold side heat sink 210.

Due to the air flow path between the cold air circulation fan 240 and the cold side heat sink 210 and the cold air circulation fan 240, the cold air generated from the cooling module 200 can be circulated inside the sealed case 100 (See arrow A in FIG. 1). Thus, it is possible to efficiently cool the LCD panel 10 forming the upper surface of the sealed case 100.

On the other hand, on the outer surface of the hot side heat sink 220, that is, on the surface opposite to the surface in surface contact with the Peltier element 230, a hot air exhaust fan 250 is installed. The hot air exhaust fan 250 is arranged to be spaced apart from the hot side heat sink 220 by a predetermined distance due to a bracket 251 installed on the outside of the hot side heat sink 220.

Specifically, the bracket 251 is formed to surround the upper surface, the bottom surface and the rear surface of the hot side heat sink 220 protruding from one side of the sealed case 100 and is coupled to the hot side heat sink 220. In addition, an installation space for installing the hot air exhaust fan 250 is provided on the rear side of the bracket 251. The rear surface of the bracket 251 is formed to be spaced apart from the rear surface of the hot side heat sink 220 by a predetermined distance, and an air flow path is formed between the hot air exhaust fan 250 and the hot side heat sink 220.

Due to the air flow path between the hot air exhaust fan 250 and the hot side heat sink 220 and the hot air exhaust fan 250, a hot air generated from the cooling module 200 can be smoothly discharged to the outside of the sealed case 100 (See arrow B in FIG. 1). Thus, the cooling module 200 can more smoothly generate a cool air, so that the LCD panel forming the upper surface of the sealed case 100 can be efficiently cooled.

Preferably, the cold side heat sink 210 and the hot side heat sink 220 include a plurality of cooling fins 211 and 221 extending in the horizontal direction and spaced apart from each other by a predetermined distance in the vertical direction. Due to the arrangement of the cooling fins 211 and 221, an air flow in the horizontal direction is generated in the cooling module 200. Thus, the circulation of cold air inside the sealed case 100 and the discharge of hot air to the outside of the sealed case 100 may be performed smoothly.

Additionally, a heat insulating material is inserted into the inner surface of the sealed case 100 to minimize the loss of cold air inside the sealed case 100.

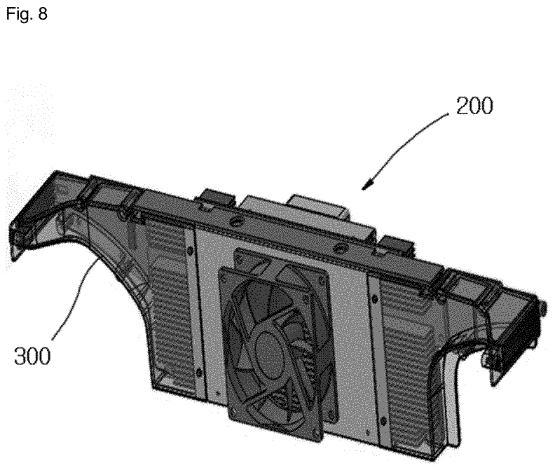

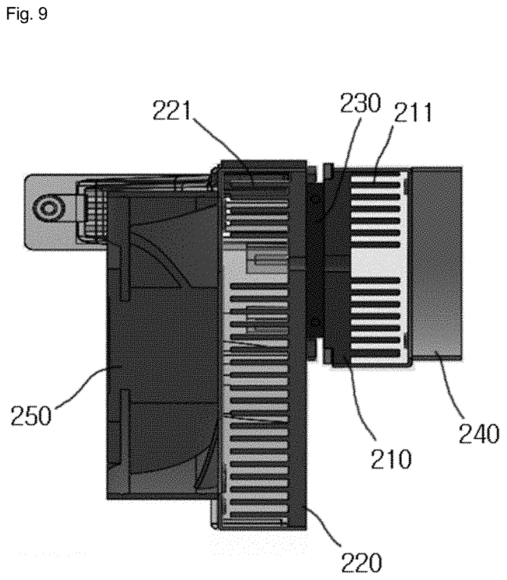

Referring to FIGS. 8 and 9, the hot side heat sink 220 may be accommodated in a duct 300 communicating with the outside of the 3D printer. Due to this duct 300, the heat radiated from the hot side heat sink 220 can also flow into the inside of the 3D printer and be discharged directly to the outside of the 3D printer without affecting other parts.

Additionally, the apparatus for cooling the LCD panel of the 3D printer according to the present invention may further include a temperature sensor (not shown) for measuring the temperature of the LCD panel 10. Therefore, in the apparatus for cooling the LCD panel of the 3D printer according to the present invention, when the temperature of the LCD panel is higher than or equal to a predetermined value, for example, when the temperature of the LCD panel 10 is higher than or equal to 26° C., current is applied to the Peltier element 230 to effectively cool the LCD panel 10.

What is claimed is:

1. An apparatus for cooling an LCD panel of a 3D printer that transmits the light irradiated from a light source module to the LCD panel and cures a photocurable resin in a water tank to produce a sculpture, the apparatus comprising:
a sealed case arranged between the light source module and the LCD panel; and
a cooling module installed on one side or lower surface of the sealed case and cooling the air inside the sealed case to cool the LCD panel.

2. The apparatus according to claim 1, wherein the cooling module comprises:
a cold side heat sink arranged inside the sealed case;
a hot side heat sink arranged outside the sealed case; and
a Peltier element installed between the cold side heat sink and the hot side heat sink, and when a current is applied, the contact surface of the Peltier element with the cold side heat sink is cooled and the contact surface of the Peltier element with the hot side heat sink is heated.

3. The apparatus according to claim 2, wherein the Peltier element is made of a pair and is arranged on the same line as one side of the sealed case, and is in surface contact with the cold side heat sink and the hot side heat sink.

4. The apparatus according to claim 2, wherein a cold air circulation fan is installed on the side opposite to one side of the cold side heat sink that is in contact with the Peltier element; and the cold air circulation fan is arranged to be spaced apart from the cold side heat sink by a predetermined distance through a bracket installed on the outside of the cold side heat sink, thereby forming an air flow path between the cold air circulation fan and the cold side heat sink.

5. The apparatus according to claim 2, wherein a hot air exhaust fan is installed on the side opposite to one side of the hot side heat sink that is in contact with the Peltier element; and the hot air exhaust fan is arranged to be spaced apart from the hot side heat sink by a predetermined distance through a bracket installed on the outside of the hot side heat sink, thereby forming an air flow path between the hot air exhaust fan and the hot side heat sink.

6. The apparatus according to claim 4, wherein the cold side heat sink and the hot side heat sink are provided with a plurality of cooling fins extending in the horizontal direction and spaced apart from each other by a predetermined distance in the vertical direction, so that an air flow in the horizontal direction is generated in the cooling module.

7. The apparatus according to claim 4, wherein the hot side heat sink is accommodated in a duct communicating with the outside of the 3D printer, so that the heat radiated from the hot side heat sink is discharged to the outside of the 3D printer without flowing into the 3D printer.

8. The apparatus according to claim 1, wherein a heat insulating material is inserted into the inner surface of the sealed case.

9. The apparatus according to claim 1, wherein the light source module forms a bottom surface of the sealed case, and the LCD panel forms an upper surface of the sealed case.

10. The apparatus according to claim 2, further comprising a temperature sensor for measuring the temperature of the LCD panel, wherein, when the temperature of the LCD panel is higher than or equal to a predetermined value as a result of the measurement of the temperature sensor, a current is applied to the Peltier element.
